(19) United States
(12) Patent Application Publication
(10) Pub. No.: US 2017/0242675 A1
(43) Pub. Date: Aug. 24, 2017

(54) SYSTEM AND METHOD FOR RECOMMENDATION AND SMART INSTALLATION OF APPLICATIONS ON A COMPUTING DEVICE

(71) Applicant: RAKESH DESHMUKH, Indore (IN)

(72) Inventor: RAKESH DESHMUKH, Indore (IN)

(21) Appl. No.: 15/407,252

(22) Filed: Jan. 16, 2017

(30) Foreign Application Priority Data
Jan. 15, 2016 (SG) 10201600320W

(51) Int. Cl. G06F 9/445; G06F 3/0482; G06F 3/0481; G06K 9/00

(52) U.S. Cl. CPC G06F 8/61; G06K 9/00671; G06F 3/0482; G06F 3/04817

(57) ABSTRACT

The present invention discloses a system and method for smart installation of applications on a computing device without logging into the computing device using an email account. The system is configured to install applications by identifying applications in a peer computing device and listing those identified applications in a target computing device. A picture of app drawing screen on a user interface of a secondary computing device is captured and displayed on the user interface of the primary computing device for analysis for identifying the applications for installation. Optionally the applications are identified from the applications available on an application store based on a browsing history and a demography of the user. The icons of the identified applications are displayed along with a checkbox for selecting the required applications. The required application are installed on the computing device alter confirming the non-availability.

### CROSS-REFERENCE TO RELATED APPLICATION

This application claims the priority of the Singapore Provisional Patent Application with serial number 10201600320W filed on Jan. 15, 2016 with the title “METHOD AND SYSTEM FOR RECOMMENDATION AND SMART INSTALLATION OF APPLICATIONS ON A COMPUTING DEVICE”, and the contents of which is incorporated in entirety as reference herein.

### BACKGROUND

Technical Field

The present invention is generally related to a system and method for recommending applications to a user for installation in a computing device. The present invention is particularly related to a system and method for smart installation of applications in the computing devices. The present invention is more particularly related to application installation on a remote computing device by a plurality of communication protocols.

Description of the Related Art

With the advent of technology, diversified applications are being developed for extending a mobile device functionality. Further, the applications on computing devices simplify the daily activities of the user and act as a personal assistant in various functions. Various types of mobile applications, or apps, are available in Application store, hereinafter referred to as App store. The types of apps include applications for information retrieval, communication, ticket booking, hotel booking, social media, food delivery, entertainment etc. An application store is a type of digital distribution platform for mobile applications.

In the age of app technology, there are millions of mobile applications available just from the application stores. Furthermore, the number of available applications is continue to increase and is expected to do so in the future. This explosive growth in the number of application stores and the number of mobile applications available from the application stores provide the mobile users with a large variety of available mobile applications.

In the currently used methods, an application installation is carried out in two methods. In one method, a user accesses the App store through an interface on a mobile computing device and browses a catalogue of available apps. Further, a user manually selects the application of his/her choice to be installed.

In another method, information about new applications is generally available through advertising, industry reviews, “top 10” and “best” lists, and through word-of-mouth referrals. A user is prompted to install an application by registering his/her mobile device with an email ID in the App store. Further, a user manually searches for a specific application among a plurality of applications in the App store. In case of smart phones, without a registered account, the application installation fails.

First time users, who are not accustomed with a smart device, request the friends for suggesting apps. However, searching and installation of applications becomes a cumbersome process for a novice user. The existing systems do not disclose a system for easy and effortless process for recommendation and installation of applications without a need for signed-in account details.

Hence, there is a need for a system and method for fetching and installing apps easily, thereby eradicating a need for logging into the phone using an email account. There is also a need for a system and method for recommending applications and provide easy installation of applications on a computing device. Further, there is a need for a system for installation of applications by identifying applications in a peer computing device and listing those identified applications in a target computing device.

### OBJECT OF THE EMBODIMENTS HEREIN

The primary object of the present invention is to provide a system and method to facilitate a smart installation of the applications on a computing device thereby eradicating a need for logging into the computing device using an email account.

Another object of the present invention is to provide a system and method for a smart recommendation for installation of the applications on a computing device.

Yet another object of the present invention is to provide a system and method for recommending applications to be installed in a first user device by a second user by capturing the screenshots of a user interface screen of a first user with a second user, and identifying the applications figured in the shared screenshot.

Yet another object of the present invention is to develop a system and method to provide application experience to a user accessing a secondary computing device by remotely sharing a user interface screen of a primary computing device with the secondary computing device.

Yet another object of the present invention is to provide a system and method for installation of applications on a first computing device using augmented reality.

Yet another object of the present invention is to provide a system and method for installation of applications on other device through any one of near field communication technology or Bluetooth

Yet another object of the present invention is to provide a system and method for a remote installation of applications on a computing device.

Yet another object of the present invention is to provide a system and method for recommending application installation to a secondary user based on browsing history and demography of a primary user.

Yet another object of the present invention is to provide a system and method to enable a primary user to send recommendations for application installation to a secondary user.

These and other objects and advantages of the present invention will become readily apparent from the following detailed description taken in conjunction with the accompanying drawings.

### SUMMARY

The various embodiments of the present invention provide a system and a method for a smart installation of applications on a computing device thereby eradicating a need for logging into the computing device using an email account. Further, the present invention provide a system for installation of applications by identifying applications in a peer computing device and listing those identified applications in a target computing device.

According to one embodiment of the present invention, a method is provided for a recommendation and smart installation of applications on a computing device without logging into the computing device using an email id by user. The method includes capturing a picture of application drawing screen on a user interface of a secondary computing device by taking a screenshot on a secondary computing device by an image rendering module or using a camera of a primary computing device. Further, the captured picture of app drawing screen is displayed on the user interface of the primary computing device or the screenshot of the secondary computing device shared through Bluetooth or Near Field communication (NFC). A plurality of applications in the captured and displayed picture of app drawing screen of the secondary device is identified by an application identification module. The captured and displayed picture of app drawing screen of the secondary device is analyzed to display a plurality of application icons for installation. The plurality of application icons are displayed along with a checkbox on the user interface of the primary computing device, by an augmented reality app capture module. Subsequently, recommendations for application are provided along with checkbox to the user for installation from a plurality of applications stored in an Application data store based on an information provided by the user context analysing module based on a browsing history and demography of the user. A user is enabled to select a checkbox associated with an application icon of a desired application from the check boxes of the plurality of icons associated with the plurality of applications displayed on the user interface of the primary computing device. Finally, the application associated with the selected checkbox is installed on the primary computing device. Further, a plurality of application selected by the user is installed on the primary computing device by an app installation module after identifying and confirming non-availability of the selected plurality of applications on the primary computing device.

According to one embodiment of the present invention, a system is provided for recommendation and smart installation of applications on a computing device without logging into the computing device using an email id by user. The system includes a hardware processor, and a computer readable medium or memory storing processor-executable instructions. The processor executable instructions are run on the hardware processor to configure the processor for activating or running or configuring an image rendering module or a camera of a primary computing device to capture a picture of an app drawing screen displayed on a user interface of a secondary computing device by taking a screenshot of the secondary computing device. The processor configures a display screen to display the captured picture of the app drawing screen displayed on the user interface of the primary computing device from the picture taken by camera of the primary computing device or the screen shot shared by the secondary computing device through a Bluetooth communication or Near Field communication (NFC). The processor configures an application identification module to identify a plurality of applications figured in the captured picture of app drawing screen of the secondary device. The processor configures an augmented reality app capture module to analyse the picture of app drawing screen of the secondary device application and to display a plurality of icons found on the picture of app drawing screen along with checkbox on the user interface of the primary computing device. The processor configures a user context analysing module to process a browsing history and demography of the user to provide a recommendation information for applications to be installed from a plurality of applications stored in an application data store. The processor configures an application recommendation module to provide recommendation for applications to be installed along with a checkbox to the user on the user interface of the primary computing device based on a recommendation information received from the user context analysing module. The application recommendation module is configured to enable a user to select a checkbox associated with an application icon of a required application for installation on the primary computing device. The processor configures an app installation module to install the application associated with the user selected checkbox on the primary computing device after confirming a non-availability of the selected application on the primary computing device. Further, the application identification module is configured to identify one or more applications for the user for installation based on a detected user context information and a stored application manifest information, and the plurality of applications in the picture captured by the image rendering module. The application installation module is further configured to install new and updated version of application available for the primary computing device based on a specific hardware, input paradigms, output paradigms, and platform expectations of the primary computing device.

According to one embodiment of the present invention, the Smart App installation system is configured to provide recommendations for application installation to a secondary user based on browsing history and demography of a primary user.

According to one embodiment of the present invention, a computer implemented method is provided for a recommendation and smart installation of applications on a computing device without logging into the computing device using an email id by user. The method comprises instructions stored on a non-transitory computer readable storage medium and executed on a computing device provided with a hardware processor and a memory for a recommendation and smart installation of applications on a computing device. The method includes capturing a picture of application drawing screen on a user interface of a secondary computing device by taking a screenshot on a secondary computing device by an image rendering module or using a camera of a primary computing device. Further, the captured picture of app drawing screen is displayed on the user interface of the primary computing device or the screenshot of the secondary computing device shared through Bluetooth or Near Field communication (NFC). A plurality of applications in the captured and displayed picture of app drawing screen of the secondary device is identified by an application identification module. The captured and displayed picture of app drawing screen of the secondary device is analyzed to display a plurality of application icons for installation. The plurality of application icons are displayed along with a checkbox on the user interface of the primary computing device, by an augmented reality app capture module. Subsequently, recommendations for application are provided along with checkbox to the user for installation from a plurality of applications stored in an Application data store based on an information provided by the user context analyzing module based on a browsing history and demography of the user. A user is enabled to select a checkbox associated with an application icon of a desired application from the check boxes of the plurality of icons associated with the plurality of applications displayed on the user interface of the primary computing device. Finally, the application associated with the selected checkbox is installed on the primary computing device. Further, a plurality of application selected by the user is installed on the primary computing device by an app installation module after identifying and confirming non-availability of the selected plurality of applications on the primary computing device.

According to one embodiment of the present invention, one or more applications to be installed for the user is identified based on a detected user context information and a stored application manifest information, and the applications in the picture captured by the image rendering module.

According to one embodiment of the present invention, the step of installing the application further involves checking and installing new and updated version of application available for the primary computing device based on specific hardware, input paradigms, output paradigms, and platform expectations of the primary computing device.

According to one embodiment of the present invention, a non-transitory computer readable medium is provided to store the computer readable instructions. The computer readable instructions, are run and executed on a hardware processor, to configure a computer enabled device to execute a method for a recommendation and smart installation of applications on a computing device without logging into the computing device using an email id by user. The method includes capturing a picture of application drawing screen on a user interface of a secondary computing device by taking a screenshot on a secondary computing device by an image rendering module or using a camera of a primary computing device. Further, the captured picture of app drawing screen is displayed on the user interface of the primary computing device or the screenshot of the secondary computing device shared through Bluetooth or Near Field communication (NFC). A plurality of applications in the captured and displayed picture of app drawing screen of the secondary device is identified by an application identification module. The captured and displayed picture of app drawing screen of the secondary device is analyzed to display a plurality of application icons for installation. The plurality of application icons are displayed along with a checkbox on the user interface of the primary computing device, by an augmented reality app capture module. Subsequently, recommendations for application are provided along with checkbox to the user for installation from a plurality of applications stored in an Application data store based on an information provided by the user context analysing module based on a browsing history and demography of the user. A user is enabled to select a checkbox associated with an application icon of a desired application from the check boxes of the plurality of icons associated with the plurality of applications displayed on the user interface of the primary computing device. Finally, the application associated with the selected checkbox is installed on the primary computing device. Further, a plurality of application selected by the user is installed on the primary computing device by an app installation module after identifying and confirming non-availability of the selected plurality of applications on the primary computing device.

According to one embodiment of the present invention, one or more applications to be installed for the user is identified based on a detected user context information and a stored application manifest information, and the applications in the picture captured by the image rendering module.

According to one embodiment of the present invention, the step of installing the application further involves checking and installing new and updated version of application available for the primary computing device based on specific hardware, input paradigms, output paradigms, and platform expectations of the primary computing device.

According to one embodiment of the present invention, the system includes a Smart App installation system for recommending applications to be installed in a first user device by capturing the screenshots of an app drawer screen of a second user device. The method comprises a selection of a smart install option by the first user through the Smart App installation system. Further, the method involves starting a camera on the first user device to capture a picture of the app drawer screen of the second computing device. Further, the smart app installation system is configured to display the picture on the first computing device and identify the applications figured in the picture. Further, the smart app installation system is configured to analyze the picture and display the application icons found in the second computing device along with a checkbox. The first user is prompted to select a checkbox associated with each application to install a respective application. Thus, the method enables the first user to install the applications unavailable in the first computing device after comparison with the second computing device.

According to one embodiment of the present invention, the system includes a Smart App installation system to provide/simulate an application experience to a first user accessing a first computing device by remotely sharing a user interface screen of a second computing device. The first user shares the screen of application interface on the first computing device with a second computing device of a second user. In this scenario, the second user is enabled to view and study the application experience on his device without installing the application.

According to one embodiment of the present invention, a Smart App installation system is provided to install applications on a first computing device using augmented reality. The method involves a first user selecting the option for a smart installation using Smart App installation system. The camera on the first computing device is activated. While the camera in the first user device is activated to capture a screen of the second computing device of the second user, the Augmented reality app capture module in the first computing device is configured to recognize the application figured on the screen of the second computing device of the second users in real-time and displays an on screen option on the camera preview screen of the first computing device to install the application.

According to one embodiment of the present invention, the Augmented reality app capture module is configured to recognize an application on the go from any computing device. The computing device includes but not limited to a laptop, tablet, and mobile phone. Further, the augmented reality app capture module is configured to prompt the user to install the application by providing an install option on the camera preview screen itself. Further, the first user need not sign in to his/her email account in the computing device to install the applications. The Smart App installation system is configured to enable the user to have an interface to install applications on the go on the camera preview screen itself.

According to one embodiment of the present invention, the Smart App installation system is provided for offering a smart recommendation for installation of applications on a computing device. The smart recommendations are provided through the methods of screen capture, screen sharing, and communication protocols. Further, the system is configured to provide recommendations for application installation to a secondary user based on browsing history and demography of a primary user.

According to one embodiment of the present invention, the Smart App installation system is provided and configured to install applications on other deuce using any one of near field communication or Bluetooth. The Smart App installation system is configured to provide an interface to enable the first user to pair the first computing device with the second computing device through any one of near field communication or Bluetooth. The first user is enabled to select an option in the interface to transfer an applications list installed on his phone to second user's device. Further, on receiving the list, the second user's phone is configured to display a screen with the application icons from the list shared from app drawer of the first user. The second User is prompted to select the checkboxes for the apps to be installed and the installation of selected applications is initiated in the second user computing device (smart phone). When an application listed in the interface is not found, the user is prompted to install one more similar application to the selected application.

According to one embodiment of the present invention, the Smart App installation system is configured to provide a remote installation of applications on a computing device.

According to one embodiment of the present invention, the Smart App installation system is configured to enable the primary user to send recommendations for application installation to the secondary user.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for recommendation and smart installation of the application on a computing device in accordance with one embodiment of the present disclosure.

FIG. 2 illustrates the bock diagram of a Smart App installation system for recommendation and smart installation of the applications on a computing device, in accordance with one embodiment of the present disclosure.

FIG. 3 illustrates a flowchart explaining a method for recommendation and smart installation of the application on a computing device, in accordance with one embodiment of the present disclosure.

Although the specific features of the present invention are shown in some drawings and not in others. This is done for convenience only as each feature may be combined with any or all of the other features in accordance with the present invention.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The present invention discloses a system and method for providing a smart installation of applications on a computing device thereby eradicating a need for logging into the computing device using an email account.

According to one embodiment of the present invention, a Smart App installation system is provided for recommending applications to be installed in a first user device by capturing the screenshots of an app drawer screen of a second user device.

According to one embodiment of the present invention, the Smart App installation system is provided to install the applications on a first computing device using augmented reality.

According to one embodiment of the present invention, the Smart App installation system is provided to install applications on other device using one of near field communication or Bluetooth.

According to one embodiment of the present invention, the Smart App installation system is provided for recommending application installation to a secondary user based on browsing history and demography of a primary user.

According to one embodiment of the present invention, the Smart App installation system is provided for a remote installation of applications on a computing device.

According to one embodiment of the present invention, the Smart App installation system is provided to enable a primary user to send recommendations for application installation to a secondary user.

According to one embodiment of the present invention, a method is provided for a recommendation and smart installation of applications on a computing device without logging into the computing device using an email id by user. The method includes capturing a picture of application drawing screen on a user interface of a secondary computing device by taking a screenshot on a secondary computing device by an image rendering module or using a camera of a primary computing device. Further, the captured picture of app drawing screen is displayed on the user interface of the primary computing device or the screenshot of the secondary computing device shared through Bluetooth or Near Field communication (NFC). A plurality of applications in the captured and displayed picture of app drawing screen of the secondary device is identified by an application identification module. The captured and displayed picture of app drawing screen of the secondary device is analyzed to display a plurality of application icons for installation. The plurality of application icons are displayed along with a checkbox on the user interface of the primary computing device, by an augmented reality app capture module. Subsequently, recommendations for application are provided along with checkbox to the user for installation from a plurality of applications stored in an Application data store based on an information provided by the user context analysing module based on a browsing history and demography of the user. A user is enabled to select a checkbox associated with an application icon of a desired application from the check boxes of the plurality of icons associated with the plurality of applications displayed on the user interface of the primary computing device. Finally, the application associated with the selected checkbox is installed on the primary computing device. Further, a plurality of application selected by the user is installed on the primary computing device by an app installation module after identifying and confirming non-availability of the selected plurality of applications on the primary computing device.

According to one embodiment of the present invention, a system is provided for recommendation and smart installation of applications on a computing device without logging into the computing device using an email id by user. The system includes a hardware processor, and a computer readable medium or memory storing processor-executable instructions. The processor executable instructions are run on the hardware processor to configure the processor for activating or running or configuring an image rendering module or a camera of a primary computing device to capture a picture of an app drawing screen displayed on a user interface of a secondary computing device by taking a screenshot of the secondary computing device. The processor configures a display screen to display the captured picture of the app drawing screen displayed on the user interface of the primary computing device from the picture taken by camera of the primary computing device or the screen shot shared by the secondary computing device through a Bluetooth communication or Near Field communication (NFC). The processor configures an application identification module to identify a plurality of applications figured in the captured picture of app drawing screen of the secondary device. The processor configures an augmented reality app capture module to analyse the picture of app drawing screen of the secondary device application and to display a plurality of icons found on the picture of app drawing screen along with checkbox on the user interface of the primary computing device. The processor configures a user context analysing module to process a browsing history and demography of the user to provide a recommendation information for applications to be installed from a plurality of applications stored in an application data store. The processor configures an application recommendation module to provide recommendation for applications to be installed along with a checkbox to the user on the user interface of the primary computing device based on a recommendation information received from the user context analysing module. The application recommendation module is configured to enable a user to select a checkbox associated with an application icon of a required application for installation on the primary computing device. The processor configures an app installation module to install the application associated with the user selected checkbox on the primary computing device after confirming a non-availability of the selected application on the primary computing device. Further, the application identification module is configured to identify one or more applications for the user for installation based on a detected user context information and a stored application manifest information, and the plurality of applications in the picture captured by the image rendering module. The application installation module is further configured to install new and updated version of application available for the primary computing device based on a specific hardware, input paradigms, output paradigms, and platform expectations of the primary computing device.

According to one embodiment of the present invention, the Smart App installation system is configured to provide recommendations for application installation to a secondary user based on browsing history and demography of a primary user.

According to one embodiment of the present invention, a computer implemented method is provided for a recommendation and smart installation of applications on a computing device without logging into the computing device using an email id by user. The method comprises instructions stored on a non-transitory computer readable storage medium and executed on a computing device provided with a hardware processor and a memory for a recommendation and smart installation of applications on a computing device. The method includes capturing a picture of application drawing screen on a user interface of a secondary computing device by taking a screenshot on a secondary computing device by an image rendering module or using a camera of a primary computing device. Further, the captured picture of app drawing screen is displayed on the user interface of the primary computing device or the screenshot of the secondary computing device shared through Bluetooth or Near Field communication (NFC). A plurality of applications in the captured and displayed picture of app drawing screen of the secondary device is identified by an application identification module. The captured and displayed picture of app drawing screen of the secondary device is analyzed to display a plurality of application icons for installation. The plurality of application icons are displayed along with a checkbox on the user interface of the primary computing device, by an augmented reality app capture module. Subsequently, recommendations for application are provided along with checkbox to the user for installation from a plurality of applications stored in an Application data store based on an information provided by the user context analysing module based on a browsing history and demography of the user. A user is enabled to select a checkbox associated with an application icon of a desired application from the check boxes of the plurality of icons associated with the plurality of applications displayed on the user interface of the primary computing device. Finally, the application associated with the selected checkbox is installed on the primary computing device. Further, a plurality of application selected by the user is installed on the primary computing device by an app installation module after identifying and confirming non-availability of the selected plurality of applications on the primary computing device.

According to one embodiment of the present invention, one or more applications to be installed for the user is identified based on a detected user context information and a stored application manifest information, and the applications in the picture captured by the image rendering module.

According to one embodiment of the present invention, the step of installing the application further involves checking and installing new and updated version of application available for the primary computing device based on specific hardware, input paradigms, output paradigms, and platform expectations of the primary computing device.

According to one embodiment of the present invention, a non-transitory computer readable medium is provided to store the computer readable instructions. The computer readable instructions, are run and executed on a hardware processor, to configure a computer enabled device to execute a method for a recommendation and smart installation of applications on a computing device without logging into the computing device using an email id by user. The method includes capturing a picture of application drawing screen on a user interface of a secondary computing device by taking a screenshot on a secondary computing device by an image rendering module or using a camera of a primary computing device. Further, the captured picture of app drawing screen is displayed on the user interface of the primary computing device or the screenshot of the secondary computing device shared through Bluetooth or Near Field communication (NFC). A plurality of applications in the captured and displayed picture of app drawing screen of the secondary device is identified by an application identification module. The captured and displayed picture of app drawing screen of the secondary device is analyzed to display a plurality of application icons for installation. The plurality of application icons are displayed along with a checkbox on the user interface of the primary computing device, by an augmented reality app capture module. Subsequently, recommendations for application are provided along with checkbox to the user for installation from a plurality of applications stored in an Application data store based on an information provided by the user context analysing module based on a browsing history and demography of the user. A user is enabled to select a checkbox associated with an application icon of a desired application from the check boxes of the plurality of icons associated with the plurality of applications displayed on the user interface of the primary computing device. Finally, the application associated with the selected checkbox is installed on the primary computing device. Further, a plurality of application selected by the user is installed on the primary computing device by an app installation module after identifying and confirming non-availability of the selected plurality of applications on the primary computing device.

According to one embodiment of the present invention, one or more applications to be installed for the user is identified based on a detected user context information and a stored application manifest information, and the applications in the picture captured by the image rendering module.

According to one embodiment of the present invention, the step of installing the application further involves checking and installing new and updated version of application available for the primary computing device based on specific hardware, input paradigms, output paradigms, and platform expectations of the primary computing device.

According to one embodiment of the present invention, the system is provided for recommendation and smart installation of applications on a computing device without the need of logging into the computing device using an email id by user. The system comprising a processor and a computer readable medium for storing the processor-executable instructions. The instructions are executed on a hardware processor to capture a picture of an app drawing screen on a user interface of a secondary computing device by capturing an image of a screenshot on the secondary computing device or using camera of a primary computing device, by an image rendering module. The captured picture of app drawing screen on user interface of the primary computing device from the picture taken by camera of the primary computing device is displayed or the picture shared by the secondary computing device taken as the screenshot using Bluetooth or Near Field communication (NFC) is displayed. The applications figured in the picture of app drawing screen of the secondary device, on the user interface of the primary computing device is identified with an application identification module. The picture of app drawing screen of the secondary device is analyzed by an augmented reality app capture module and the application icons found on the picture of app drawing screen are displayed along with checkbox on the user interface of the primary computing device. The recommendations for applications is optionally provided along with checkbox to the user based on the information provided by the user context analyzing module taking into consideration the browsing history and demography of the user, from the applications stored in an application data store. The user is prompted/enabled to select the checkbox associated with the application icons appearing on the user interface of the primary computing device by the user for installation of the applications. The applications that are selected by the user and are unavailable on the primary computing device, are installed on the primary computing device by an app installation module.

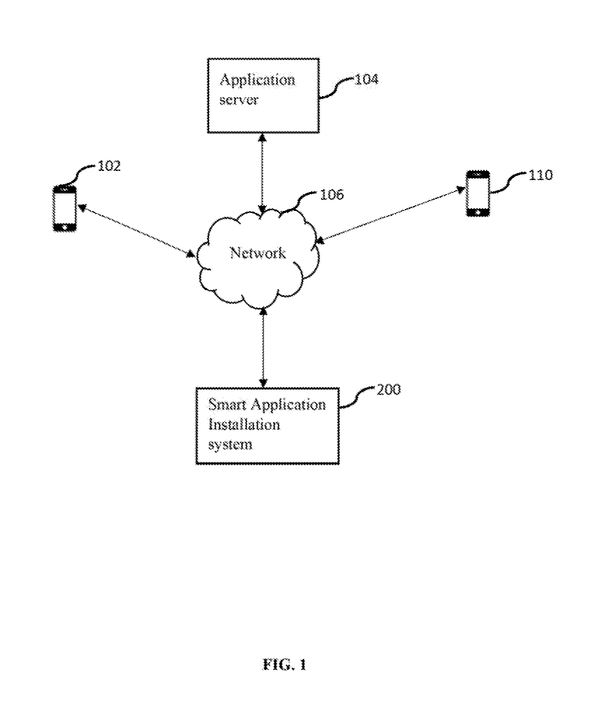

FIG. 1 illustrates a block diagram of a system for recommendation and smart installation of the application on a computing device in accordance with one embodiment of the present disclosure. The system includes the computing devices 102 and 110 that communicate with an application server 104 over a network 106. The user computing devices 102 and 110 are associated with a first user and a second user respectively. The network 106 includes a large computer network, such as a local area network (LAN), a wide area network (WAN), the Internet, a cellular network, or a combination thereof connecting any number of mobile computing devices, fixed computing devices and server systems.

The computing devices 102 and 110 are any type of computing device but not limited to a desktop computer, a laptop computer, a handheld computer, a personal digital assistant (PDA), a cellular telephone, a tablet, a network appliance, a camera, a smart phone.

The computing devices 102 and 110 enable the respective users to interact with an application marketplace. An example application marketplace includes Google Play (formerly known as the Android Market) provided by Google Inc. According to one embodiment herein, the application marketplace includes a website that is hosted on one or more servers (e.g., the server system 104) and is accessed using a computing device (e.g., computing devices 102 and 110). According to one embodiment herein, the application marketplace is provided as an application that is executed on a computing device (such as computing devices 102 and 110), and that retrieves application information from one or more servers. The smart application installation system 200 is configured to interact with the first computing device 102 and second computing device over a network 106.

According to one embodiment of the present invention, the system includes a Smart App installation system 200 for recommending applications to be installed in a first user device by capturing the screenshots of an app drawer screen of a second user. The method includes selection of a smart install option by the first user through the Smart App installation system. Further, the camera on the first user device is activated to capture an image or picture of the app drawer screen of the second computing device. The smart app installation system is configured to display the picture on the first computing device and identify the applications in the picture. The smart app installation system is configured to analyze the picture and displays the application icons found in the second computing device along with a checkbox. The first user is prompted or enabled to select the checkbox associated with each application to install the respective application. Thus, the first user is enabled to install the applications unavailable in the first computing device after comparison with the second computing device.

According to one embodiment of the present invention, the Smart App installation system is configured to provide an application experience to a first user accessing a first computing device by remotely sharing the user interface screen of a second computing device. The first user shares the screen of application interface on the first computing device with a second user through the second computing device. In this scenario, the second user is enabled to view and study the application experience on his device without installing the application.

According to one embodiment of the present invention, the Smart App installation system is configured to install applications on a first computing device using augmented reality. The method involves a first user selecting the option for smart install using Smart App installation system. The camera on the first computing device is activated. When the first user is enabled/prompted to point his camera at the screen of computing device of the second user, the Augmented reality app capture module in the first computing device is configured to recognize the application on the screen of the second user computing device in real-time and displays an on screen option on the camera preview screen of the first computing device for installing the application.

According to one embodiment of the present invention, the Augmented reality app capture module is configured to recognize the applications on the go from any computing device including but not limited to a laptop, tablet, and mobile phone. Further, the augmented reality app capture module is configured to prompt the user to install the application by providing an install option on the camera preview screen itself. Further, the first user need not sign in to his/her email account in the computing device to install the applications. Further, the smart application installation system is configured to enable the users to select any one of ‘sign-in’ and ‘no sign-in’ feature on his/her computing device. For security reasons, the user chooses to set a password or a protection layer that needs to be cleared before installation. Thereby, the smart app installation system is configured to authenticate the installation process. The Smart App installation system is configured to enable the user to have an interface to install applications on the go on the camera preview screen itself.

According to one embodiment of the present invention, the Smart App installation system is configured to provide recommendations for application installation to a secondary user based on browsing history and demography of a primary user.

According to one embodiment of the present invention, the Smart App installation system is configured to install applications on other device using one of near field communication or Bluetooth. The Smart App installation system is configured to provide an interface through which the first user chooses to pair the first computing device with the second computing device using one of near field communication or Bluetooth. The first user is prompted to select an option in the interface to transfer the applications list installed on his phone to the second users device, when the first user's device displays a screen with the application icons from the list shared from second user after receiving the list. The second user selects the checkboxes for the apps he wants to install. The selected applications are downloaded and installed on his phone. When an application listed in the interface is not found, the user is prompted to install one more similar applications to the selected application.

According to one embodiment of the present invention, the Smart App installation system is configured to provide a remote installation of the applications on a computing device.

According to one embodiment of the present invention, the Smart App installation system is configured to provide a smart recommendation for installation of applications on a computing device. The recommendations for application installation to a secondary user is provided based on a browsing history and demography of a primary user.

According to one embodiment of the present invention, the Smart App installation system is provided to enable a primary user to send recommendations for application installation to a secondary user.

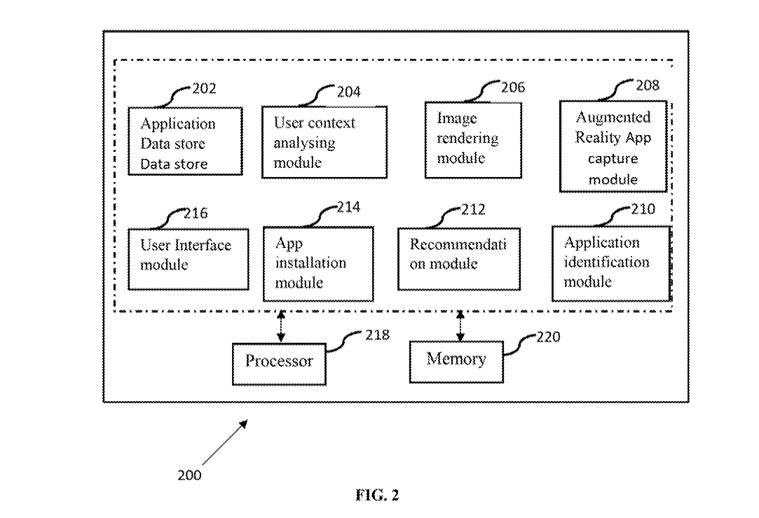

FIG. 2 illustrates the bock diagram of Smart App installation system for recommendation and smart installation of the applications on a computing device, in accordance with one embodiment of the present disclosure. The Smart App installation system 200 comprises the application data store 202, the user context analyzing module 204, the image rendering module 206, the augmented reality capture module 208, the user Interface module 216, the app installation module 214, the recommendation module 212, and the application Identification module 210. The Smart App installation system 200 is controlled by the processor 218. Further, the memory 220 is a computer readable medium storing processor-executable instructions. The processor executable instructions are run on the hardware processor to configure the processor for activating or running or configuring the application data store 202, the user context analyzing module 204, the image rendering module 206, the augmented reality capture module 208, the user Interface module 216, the app installation module 214, the recommendation module 212, and the application Identification module 210.

The application data store 202 is configured to provide a repository of applications from which a user selects the applications for installation on the user's computing device. The application data store 202 is configured to receive the applications from application developers along with a descriptive information, contextual tags, and other information associated with each application that helps users find the application and determine the application's purpose.

The user context analyzing module 204 is configured to detect a contextual information related to the computing device and one or more activities performed by the user on the device. The module is configured to detect the information about the application browsing history, and user's demographic data. Further, the contextual information include information from the user's calendar, identification of applications that are run, information that describes activities that the user is currently engaged in.

The Image rendering module 206 is configured to operate a camera in a first computing device to capture the image of the app drawer on a second computing device, when the smart application installation system is activated.

When first user points his camera at the app drawer screen of the second computing device, the augmented reality app capture module 208 in the first computing device is configured to recognize the applications on the camera preview screen of the app drawer screen. Further, the augmented reality app capture module 208 is configured to display an option on the camera preview screen of the first computing device to install the application.

The Augmented reality app capture module 208 is configured to recognize the application on the go from any computing device including but not limited to a laptop, tablet, and mobile phone. Further, the augmented reality app capture module 208 is configured to prompt the user to install the application by providing an install option on the camera preview screen itself. Further, the first user need not sign in to his/her email account in the computing device to install the applications. Further, the smart application installation system is configured to enable the users to select one of ‘sign-in’ and ‘no sign-in’ feature on his/her computing device. For security reasons, the user is enabled to choose and set a password or a protection layer that needs to be cleared before installation. Thus, the user secures the installation process and prevents application installation by unauthorized users. The Smart App installation system is configured to enable the user to have an interface to install applications on the go on the camera preview screen itself.

The application identification component 210 is configured to identify one or more applications for the user to install based on the detected user context information and the stored application manifest information. The application identification module 210 is configured to identify the applications in the picture captured by the image rendering module 206 on a first device and displays the icons of the identified applications on the second computing device.

The Recommendation module 212 is configured to provide recommendations for application installation to a secondary user based on the information provided by the user context analyzing module 204. The Recommendation module 212 takes into consideration the browsing history and demography of a primary user. Further, the Recommendation module 212 is configured to enable the primary user to send recommendations for application installation to the secondary user.

The app installation module 214 is configured to install a selected application and configure the application based on detected context information related to the computing device. Each computing device include specific hardware, input paradigms, output paradigms, and platform expectations that the app installation module 214 communicates to the newly installed applications.

The user interface module 216 is configured to provide a user interface through which the user or an application developer interacts with the modules in the smart app installation system. The user interface module 216 is configured to enable the user to select options for screen capture, screen sharing using Bluetooth or NFC, application installation.

According to an embodiment herein, the computing device includes but not limited to cell phones, personal digital assistants, smart phones, personal computers, programmable consumer electronics, and digital cameras.

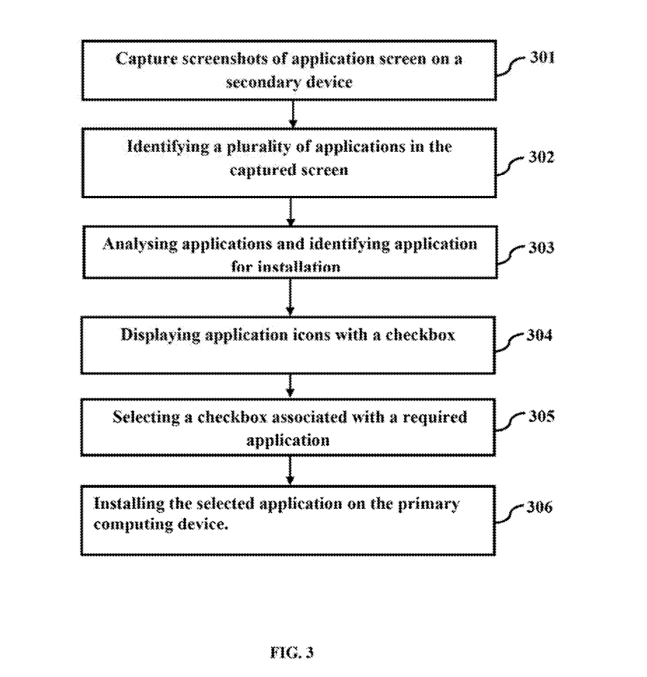

FIG. 3 illustrates a flowchart explaining a method for a recommendation and smart installation of applications on a computing device, according to an embodiment herein. The method provides an application experience to a first user accessing a primary computing device by remotely sharing the user interface screen of a secondary computing device. The first user shares the screen of application interface on the primary computing device with a second user through the secondary computing device. In this scenario, the second user is enabled to view and study the application experience on his device without installing the application and logging into the device using email ID of the user.

According to an embodiment herein, the method includes capturing a picture of application drawing screen on a user interface of a secondary computing device by taking a screenshot on a secondary computing device by an image rendering module or using a camera of a primary computing device (301). Further, the captured picture of app drawing screen is displayed on the user interface of the primary computing device or the screenshot of the secondary computing device shared through Bluetooth or Near Field communication (NFC). A plurality of applications in the captured and displayed picture of app drawing screen of the secondary device by an application identification module is identified (302). The captured and displayed picture of app drawing screen of the secondary device is analyzed to display a plurality of application icons for installation (303). The plurality of application icons are displayed along with a checkbox on the user interface of the primary computing device, by an augmented reality app capture module (304). Subsequently, recommendations for application are provided along with checkbox to the user for installation from a plurality of applications stored in an Application data store based on an information provided by the user context analysing module based on a browsing history and demography of the user. A user is enabled to select a checkbox associated with an application icon of a desired application from the check boxes of the plurality of icons associated with the plurality of applications displayed on the user interface of the primary computing device (305). Finally, the application associated with the selected checkbox is installed on the primary computing device. Further, a plurality of application selected by the user is installed on the primary computing device by an app installation module after identifying and confirming non-availability of the selected plurality of applications on the primary computing device (306).

According to an embodiment herein, the present invention provides a smart installation of applications on a computing device without being logged into the computing device using an email account. Further, the present invention recommends applications to be installed in a first user device by capturing the screenshots of an app drawer screen of a second user device. Further, the augmented reality app capture module in the present invention provides an on screen option on the camera preview screen of the first computing device to install the application. The present invention provides installation of applications on other device using any one of near field communication or Bluetooth. The present invention provides recommendations for application installation to a secondary user based on browsing history and demography of a primary user. The present invention provides a remote installation of applications on a computing device.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A system for recommendation and smart installation of applications on a computing device without logging into the computing device using an email id by user, the system comprising:
a hardware processor; and
a computer readable medium storing processor-executable instructions, and wherein the processor executable instructions are run on the hardware processor to configure the processor for activating or running or configuring:
an image rendering module or a camera of a primary computing device to capture a picture of an app drawing screen displayed on a user interface of a secondary computing device by taking a screenshot of the secondary computing device;
a display screen to display the captured picture of the app drawing screen displayed on the user interface of the primary computing device from the picture taken by camera of the primary computing device or the screen shot shared by the secondary computing device through a Bluetooth communication or Near Field communication (NFC);
an application identification module to identify a plurality of applications figured in the captured picture of app drawing screen of the secondary device;
an augmented reality app capture module to analyse the picture of app drawing screen of the secondary device application and to display a plurality of icons found on the picture of app drawing screen along with checkbox on the user interface of the primary computing device;
a user context analysing module to process a browsing history and demography of the user to provide a recommendation information for applications to be installed from a plurality of applications stored in an application data store;
an application recommendation module to provide recommendation for applications to be installed along with a checkbox to the user on the user interface of the primary computing device based on a recommendation information received from the user context analysing module, and wherein the application recommendation module is configured to prompt the user to select a checkbox associated with an application icon of a required application for installation on the primary computing device; and
an app installation module to install the application selected by the user on the primary computing device after confirming a non-availability of the selected application on the primary computing device.

2. The system as claimed in claim 1, wherein the application identification module is configured to identify one or more applications for the user for installation based on a detected user context information and a stored application manifest information, and the plurality of applications in the picture captured by the image rendering module.

3. The system as claimed in claim 1, wherein the application installation module is further configured to install new and updated version of application available for the primary computing device based on a specific hardware, input paradigms, output paradigms, and platform expectations of the primary computing device.

4. A computer implemented method comprising instructions stored on a non-transitory computer readable storage medium and executed on a computing device provided with a hardware processor and a memory for a recommendation and smart installation of applications on a computing device without logging into the computing device using an email id by user, wherein the method comprising steps of:
capturing a picture of application drawing screen on a user interface of a secondary computing device by taking a screenshot on a secondary computing device by an image rendering module or using a camera of a primary computing device;
displaying the captured picture of app drawing screen on the user interface of the primary computing device or the screenshot of the secondary computing device shared through Bluetooth or Near Field communication (NFC);
identifying a plurality of applications in the captured and displayed picture of app drawing screen of the secondary device by an application identification module;
analysing the captured and displayed picture of app drawing screen of the secondary device and displaying a plurality of application icons found on the picture of app drawing screen along with a checkbox on the user interface of the primary computing device, by an augmented reality app capture module;
optionally providing recommendations for application along with checkbox to the user for installation from a plurality of applications stored in an Application data store based on an information provided by the user context analysing module based on a browsing history and demography of the user;
selecting a checkbox associated with an application icon of a required application to be installed by the user from the check boxes of the plurality of icons associated with the plurality of applications appearing on the user interface of the primary computing device; and
installing the plurality of applications selected by the user on the primary computing device by an app installation module after identifying and confirming a non-availability of the selected plurality of applications on the primary computing device.

5. The method as claimed in claim 4, wherein one or more applications to be installed for the user is identified based on a detected user context information and a stored application manifest information, and the applications in the picture captured by the image rendering module.

6. The method as claimed in claim 5, wherein the step of installing the application further involves checking and installing new and updated version of application available for the primary computing device based on specific hardware, input paradigms, output paradigms, and platform expectations of the primary computing device.

7. A non-transitory computer readable medium having computer readable instructions stored thereupon, said computer readable instructions, when executed by a processor, to configure a computer enabled device to:
capture a picture of app drawing screen on a user interface of a secondary computing device by taking a screenshot on a secondary computing device by an image rendering module or using a camera of a primary computing device;
display the captured picture of app drawing screen on the user interface of the primary computing device or the screenshot of the secondary computing device shared through Bluetooth or Near Field communication (NFC);
identify a plurality of applications in the captured and displayed picture of app drawing screen of the secondary device by an application identification module;
analyse the captured and displayed picture of app drawing screen of the secondary device and display a plurality of application icons found on the picture of app drawing screen along with a checkbox on the user interface of the primary computing device, by an augmented reality app capture module;
optionally provide recommendations for application along with checkbox to the user for installation from a plurality of applications stored in an Application data store based on an information provided by the user context analysing module based on a browsing history and demography of the user;
select a checkbox associated with an application icon of a required application to be installed by the user from the check boxes of the plurality of icons associated with the plurality of applications appearing on the user interface of the primary computing device; and
install the plurality of applications selected by the user on the primary computing device by an app installation module after identifying and confirming a non-availability of the selected plurality of applications on the primary computing device.

8. The non-transitory computer readable medium as claimed in claim 7, wherein the computer enabled device is further configured to identify one or more applications for installation based on a detected user context information and a stored application manifest information, and the applications in the picture captured by the image rendering module.

9. The non-transitory computer readable medium as claimed in claim 7, wherein the computer enabled device is further configured to install new and updated version of application available for the primary computing device based on specific hardware, input paradigms, output paradigms, and platform expectations of the primary computing device.
